(19) United States
(12) Patent Application Publication
(10) Pub. No.: US 2020/0177399 A1
(43) Pub. Date: Jun. 4, 2020

(54) RESPONSE EXTRACTION FOR MEMORIES BASED PHYSICAL UNCLONABLE FUNCTION

(71) Applicant: QUANTUM BASE LIMITED, Cheshire (GB)

(72) Inventors: Phillip Speed, Lancaster (GB); Utz Alfred Frtiz Roedig, Lancaster (GB); Robert James Young, Lancaster (GB); Daniel David Campbell Prince, Lancaster (GB)

(21) Appl. No.: 16/324,164

(22) PCT Filed: Oct. 5, 2017
(86) PCT No.: PCT/GB2017/053008

§ 371 Date: Feb. 8, 2019

(30) Foreign Application Priority Data
Oct. 6, 2016 (GB) 1616973.2

(51) Int. Cl. H04L 9/32; G06N 10/00

(52) U.S. Cl. CPC H04L 9/3278; G06N 10/00

(57) ABSTRACT

According to a first aspect of the present invention, there is provided a device arranged to provide a specific output in response to a specific input, the device comprising: a physical unclonable function, arranged to be challenged with an input and to provide an output in response to that input; the device being arranged to facilitate the detection of a unique output of the physical unclonable function, by a detection arrangement, in response to the specific input; an offset arrangement, configured to receive the unique output, and provide a specific offset to the unique output, in order to provide the specific output of the device in response to the specific input to the device.

The present invention relates generally to providing a specific output in response to a specific input, in terms of a device and system for such generating, and a related method.

A specific output might be required for a specific input for any one of a number of reasons. For example, it might be that control of or access to a system or part thereof might only be possible if a specific input is used, for example a key or similar. This could be physical, for example in the case of a lock to a door. In that example, the specific output to the specific input is the physical key unlocking the door. In another case, the system could comprise one or more electrical, optical or optoelectronic components. In this example, functionality of the system might be selectively controlled (e.g. enabled or disabled, amplified or attenuated) by use of a signal being or comprising a key, for example a security code, an identifier, and so on.

As with any security involving keys required to lock or unlock something, or more generally involving a specific input to obtain a specific output, the level of security can be controlled. For example, the key, or specific input, can be made very difficult to easily replicate or stumble across in a statistical sense, or the processing of the input can be made very difficult to easily replicate or stumble across, all so that the specific output is obtained only as intended.

It is an example aim of example embodiments of the present invention to at least partially obviate or mitigate at least one disadvantage of the prior art, whether identified herein or elsewhere, or to at least provide an alternative to the prior art.

According to a first aspect of the present invention, there is provided a device arranged to provide a specific output in response to a specific input, the device comprising: a physical unclonable function, arranged to be challenged with an input (e.g. the specific input) and to provide a unique output in response to that input; the device being arranged to facilitate the detection of a feature of the unique output of the physical unclonable function, by a detection arrangement, in response to the specific input; an offset arrangement, configured to receive an output from the detection arrangement that is dependent on the detection of the feature of the unique output, and provide a specific offset to this output, in order to provide the specific output of the device in response to the specific input to the device.

If an input to the device is not the specific input, an output of the device is not the specific output; and/or if an output of the physical unclonable function does not comprise the feature, an output of the device is not the specific output.

The offset arrangement may be subsequently arranged to provide the same specific offset to the output of the detection arrangement, regardless of the output of the detection arrangement, or an output of the physical unclonable function.

The offset arrangement may be engineered or programmed in advance with reference to the specific output of the device, in order to provide the specific offset.

The detection arrangement may be part of the device.

The detection arrangement may be arranged to provide an output external to the device, such that it is possible to determine, external to the device, the output of the physical unclonable function.

Output of the detection arrangement external to the device may be controlled via an electrically controllable switch or fuse.

The physical unclonable function may comprise a structure that exhibits quantum mechanical confinement, the structure being arranged to provide a unique response when challenged, the unique response being linked to the atomic makeup of the structure that defines the quantum mechanical confinement.

The challenge may comprise the device facilitating an electrical measurement of an output of the structure, the electrical output optionally involving tunneling.

The device might comprise a time limitation element, arranged to impose a time limit as to when the physical unclonable function can be challenged, optionally after a previous challenge.

According to a second aspect of the present invention, there is provided a system, comprising a plurality of devices according to the first aspect of the invention, connected in parallel.

According to a third aspect of the present invention, there is provided a system, comprising a master sub-system and a slave sub-system connected to one another, the master sub-system comprising one or more devices according to the first aspect of the invention, and the slave sub-system comprising one or more devices according to the first aspect of the invention, the master sub-system being used to control one or more features of the slave-subsystem.

According to a fourth aspect of the present invention, there is provided a system, comprising: the device according to the first aspect of the invention, serving as a first device; and a second device, comprising the detection arrangement, the second device being connected or connectable to the first device in order to perform the detection of the feature of the unique output of the physical unclonable function, and to optionally provide an output that is dependent on the detection of the feature to the offset arrangement.

According to a fifth aspect of the present invention, there is provided an electrical circuit comprising the device or system of a preceding aspect of the invention, wherein at least a component of the electrical circuit is arranged to be controlled (e.g. enabled or disabled amplified or attenuated) depending on whether the output of the device or system is the specific output.

According to a fifth aspect of the present invention, there is provided a method of providing a specific output from a device in response to a specific input to the device, the method comprising: detecting a feature of a unique output of a physical unclonable function of the device in response to the specific input; providing a specific offset that is dependent on the detection of the feature of the unique output, in order to provide the specific output from the device in response to the specific input to the device.

For the avoidance of any doubt, one or more features described in relation to any one aspect of the present invention may be used in combination with or in place of any one or more features of another aspect of the present invention, unless such replacement or combination would be understood by the skilled person from a reading of this disclosure to be mutually exclusive. For example, and more particularly, any feature described in relation to an apparatus aspect of the present invention may be readily used in place of or in combination with any feature described in relation to a system of method aspect of the present invention.

For a better understanding of the invention, and to show how embodiments of the same may be carried into effect, reference will now be made, by way of example, to the accompanying diagrammatic Figures in which:

### BRIEF DESCRIPTION OF THE DRAWINGS

FIG. 1 schematically depicts a device for generating a unique response to a challenge, according to an example embodiment;

FIG. 2 is a graph schematically depicting different unique responses to challenges of different structures or combination of structures, of the device of FIG. 1, according to an example embodiment;

FIG. 3 is a device for providing a specific output in response to a specific input, according to an example embodiment;

FIG. 4 schematically depicts principles associated with the specific input, specific output, and associate specific offset, according to an example embodiment;

FIG. 5 is a graph schematically depicting principles associated with the derivation of a unique response from an electrical measurement, according to an example embodiment;

FIG. 6 schematically depicts a system comprising a plurality of devices according to an example embodiment, the devices being connected in parallel;

FIG. 7 schematically depicts a system comprising a master sub-system, comprising a plurality of devices according to an example embodiment, connected to a slave sub-system, comprising a plurality of devices according to an example embodiment.

FIG. 8 schematically depicts a system according to an example embodiment, comprising first and second devices; and

FIG. 9 schematically depicts a general methodology according to example embodiment.

According to general principles associated with the present invention, it has been realised that devices for providing a specific output in response to a specific input can be vastly improved by employing a physical (sometimes referred to as physically) unclonable function (PUF) within the device.

Typically, unique identification of products leaving a manufacturer or the like can be managed by tagging or fingerprinting those products, specifically by including a unique, difficult to clone (physical) function that can easily and repeatedly be read. A physical unclonable function can provide such identification, for example in terms of providing a unique response to a challenge. Instead of providing a unique identifier for the device, it has now been realised that the physical unclonable function can be used to ensure that a specific output of a device (e.g. for enabling or disabling a part of a circuit) is only achievable when the input is extremely specific, all linked to the unique way in which the physical unclonable function responds to a challenge.

The way in which a physical unclonable function responds to a challenge exhibits a high degree of uniqueness, a term used in the art. “Unique” might mean that it is statistically improbable that the input-output response (or challenge-response pair) might be stumbled across randomly, at least in a practical timeframe relative to use of the device or system in question. Similarly, this means that the challenge to the device would also need to be equally unique in order to generate that unique response. Following on from that, it can be seen that the physical unclonable function part of the device serves, or ensures that the device as a whole serves, as a lock or tumbler in a lock. Only if the input to the device is the unique specific input will the device respond with unique specific output. In an analogy, if the input to the device is the correct key, the device, or circuitry downstream, can be locked or unlocked, enabled or disabled.

Typically, a physically unclonable function is provided on the basis of what would commonly be considered as macroscopic, or classical physical principles. For instance, a physically unclonable function may be based on minute changes in quartz crystal oscillation frequency between different crystals, or the different capacitances between different devices as a result of different thicknesses of layers constituting those different devices, or the identification of anomalies (e.g. dead cells) in an array of memory cells. There is little doubt that these approaches do work in practice, to an extent, and may work perfectly well in certain applications. However, they do, nevertheless, have disadvantages. It has been realised that a main reason for these disadvantages is the utilisation of macroscopic effects in the generation of the unique response. For instance, this might limit the uniqueness of the input-response pair, and thus might limit the uniqueness of the input to the device to achieve the specific out. Or, the use of macroscopic effects might make it more difficult to in some way measure, encode or otherwise define the unique response. Also, using macroscopic effects, repeatability and consistency in the determination or generation of a unique response may sometimes be compromised, or require significant space or power consumption in a device that provides the identifier.

It has been realised that at least some of the problems discussed above may be overcome by using a structure that exhibits quantum mechanical confinement as, or as part of, the physical unclonable function.

The quantum mechanical nature of the implementation typically allows the device or its structures to be small, and be low power. Device fabrication might also be generally cheaper than devices used in macroscopic methods. By the very nature of devices or structures exhibiting quantum mechanical confinement, the device or structure does not need to be a dedicated external device or structure—i.e. the device or structure can be part of a device or structure (e.g. on a chip of a system) that has other functionality, related to or completely separate from the unique response generation.

Perhaps most importantly, however, is that the quantum mechanical nature of the structures allows for the response to a challenge to be particularly unique, repeatable, and consistent. This is particularly the case when the quantum mechanical effect that is measured is, or is based on or derived from, a spectrum or spectra (e.g. a combination or convolution of more than one spectrum, or measurements or more than one distinct spectrum). For instance, a device or structure exhibiting quantum mechanical confinement, particularly in two or more dimensions, may provide a unique measurable spectrum of specific confinement energy levels of electrons or holes in the structure of the device (or part thereof) that exhibits the confinement. Typically this part of the structure may be a nano-structure (or similar) in the form of a well, wire, layer, ring, dot, or other structure, that has spatial dimensions at or below length scales corresponding to the de Broglie wavelength of electrons in the system. The physical properties of such a nano-structure (or similar), including its atomic arrangement, size and composition, and the exact form of fields (e.g. strain, magnetic and electric) through the structure may all have an influence on the energies at which charge carriers are confined, according to solutions of the Schrodinger equation for the system. As will be appreciated, it is practically impossible to fabricate two structures that share all of these properties (and possibly more), so no two structures will be exactly the same. Therefore, the nature of confinement will not be the same, and therefore no two measurable quantum mechanical effects as a result of that confinement will be the same. So, the measurable quantum mechanical effect for such a structure can be used to provide a unique response for that device or a structure thereof. In other words, it has been realised that the confining structure (or, in general, confinement) provides an efficient and effective physical unclonable function. Following from this, a device having such a structure allows for a very specific output to be obtained with only a very specific input. Also, it is not possible to determine the input-output response of the structure, and thus how to obtain the very specific output of the device, without being able to characterise the structure. Access to such characterisation can be more easily controlled when the input-response is based on quantum, rather than macroscopic, effects.

The use of electrical measurements, or measurements of electrical properties of the device or constituent structures, may be advantageous over, for example, optical properties and/or measurement. The use of an electrical based approach allows for simple, quick and effective input-output response generation or characterisation, for example on a chip, or within or as part of an electric circuit or device. In contrast, optical techniques might require more complex equipment, or more numerous components, or external components, which could add to cost, complexity, weight, and so on.

Principles underlying the invention, and example implementations of the invention, will now be described, by way of example only, with reference to the Figures. The Figures have not been drawn to any particular scale, and are simply provided as diagrammatic aids for understanding the principles underlying the invention, and/or its application.

FIG. 1 schematically depicts a device for generating unique responses to challenges, to help explain how a physical unclonable function finds application in the present invention. The device comprises a variable voltage source 2 and a current measuring device 4. Connected in series with the voltage source 2 and current measuring device 4 is a part of the device that exhibits quantum mechanical confinement 6, and which serves as the physical unclonable function. This particular part of the device 6 is shown in generic form, and is indicated as comprising one or more resonant tunneling diodes, which might be a convenient form of device for use in embodiments of the present invention. Such diodes are readily available, and provide electrical output spectra which are easy to characterise in terms of peaks in those spectra, which may be useful for determining unique responses. The resonance is important in the generation of such peaks, as is the underpinning quantum mechanical tunneling.

The part of the device 6 may be controlled to determine which of the diodes, or which combination of diodes, within the part of the device 6 are challenged, for instance by provision of power from the voltage source 2, with the resulting output being measured by the current measuring device 4.

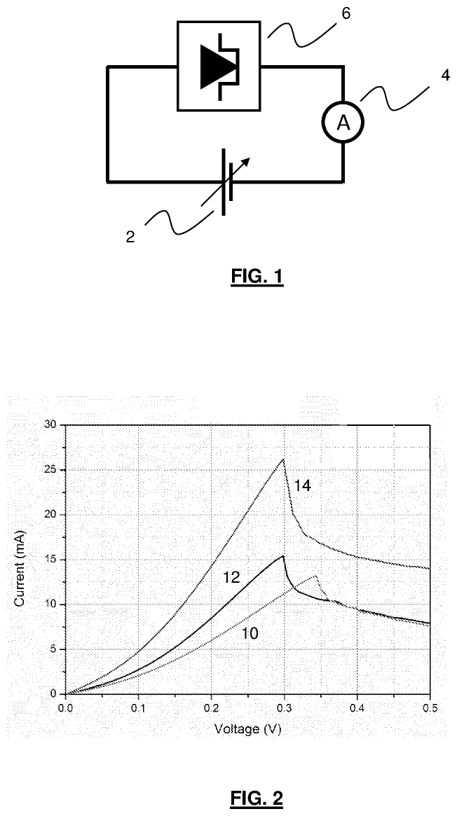

FIG. 2 is a graph schematically depicting responses to challenges of the part of the device exhibiting quantum mechanical confinement already described in relation to FIG. 1. FIG. 2 shows that if a first diode 10 is challenged, a unique voltage-current spectrum results. This is a unique response, which also comprises unique features, for example locations of peaks, widths of peaks, gradients of peaks and so on. If a different diode 12 is challenged, a different unique spectrum and thus response, is obtained. If another diode 14 is challenged, another different unique spectrum and thus response, is obtained. Each unique response will, of course, have its own unique features. Therefore, this already shows that different unique responses, including unique features, can be obtained from the device, simply by challenging different structures within the device that exhibit quantum mechanical confinement, or by using devices that have different structure that exhibit quantum mechanical confinement. As alluded to above, the devices/structures may nominally be ‘the same’ in terms of being in a same batch, or made in the same way, and so on. However, the quantum mechanical effects that are involved mean that even the ‘same’ devices within a batch will each exhibit a unique response.

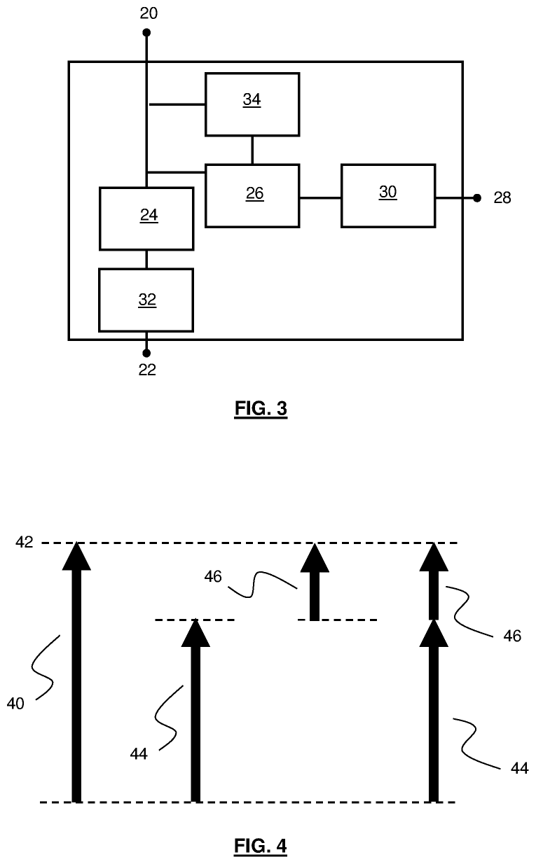

It is the sort of unique responses shown in FIG. 2 which can be taken advantage of to ensure that a very specific output can only be achieved by use of a very specific input. FIG. 3 provides a practical example.

FIG. 3 schematically depicts a device arranged to provide a specific output 20 in response to a specific input 22. The device comprises a physical unclonable function 24, arranged to be challenged with an input and to provide an output in response to that input. The physical unclonable function 24 could take any form. However, a physical unclonable function 24 that involves quantum mechanical effects in terms of responding to electrical challenges, such as a resonant tunneling diode, may be preferred for the reasons given above.

The physical unclonable function 24 is in connection with a detection arrangement 26. The detection arrangement 26 is arranged to detect a feature of a unique output of the physical unclonable function 24. This could be a spectrum or similar, or a very particular unique feature of such a spectrum, for example relating to a peak or trough.

The detection arrangement 26 is able to provide an output external to the device 28. Via this output 28, it is possible to determine what input 22 resulted in the output from the physical unclonable function 24 being or comprising the unique response that is to be used by the device for generating the specific output 20. That is, the external output 28 can be used to read the physical unclonable function 24 or the detection arrangement 26, in order to determine what the specific input to the device needs to be in order to generate the specific output. In an analogy, the external output 28 can be used to determine the ‘key’ to or of the device.

The external output might be via an electronically controllable switch or fuse 30. After the output 28 has been used to read what specific input is required, the switch or fuse 30 can be activated to prevent further reading via the output 28. This improves the security of the device, since it is then no longer possible to determine what the specific input is that results in the specific output, apart from by trial and error using different inputs 22. Even this trial and error approach can be limited or controlled, for example by incorporating a time limitation element 32 into the device. The time limitation element 32 is arranged to impose a time limit as to when the physical unclonable function 24 can be challenged, optionally after a previous challenge. The time limitation element 32 could be permanently activated, or activated at certain times, for example after a challenge, or when the switch or fuse 30 is activated to prevent further reading via the output 28.

In another example, the detection arrangement could be located external to the device, and detection could be undertaken external to the device, as and when necessary. However, this introduces a security flaw. Having the detection undertaken within, and integral to, the device removes or at least severely limits such a flaw.

The output from the detection arrangement 26, for example relating to the detection of the unique feature, can be used to prevent further variation of inputs, or input in general, to the physical unclonable function 24. This might therefore be used to end the input phase of the setup of the device, or similar.

Referring back to FIG. 3, the detection arrangement 26 is arranged to provide an output to an offset arrangement 34. The offset arrangement 34 is configured to receive the output, and provide a specific offset to the output. The offset arrangement 34 is arranged to provide the same specific offset to the output of the detection arrangement, regardless of the subsequent outputs of the physical unclonable function 24 or detection arrangement 26. That is, the offset remains fixed, unless of course there is a need to in someway reset the offset, for example if the device itself is reset to provide a new key or similar.

A switch or other component could be activated or deactivated, or changed from one state to another, once the feature detection (e.g. input sweep or variation) phase is complete. After this the detection arrangement 26 may play no part in the operation of the device, unless or until the device is reset in some way, for example for changing of the key. For example, the device could be reset by heating of the PUF, as discussed herein. The heating itself, or a separate signal, could trigger the detection arrangement to, again, be receptive to detection of the unique feature, and providing a dependent output.

The offset is, of course, not arbitrary. FIG. 4 is used to explain what the offset is, and why it is used.

FIG. 4 shows that it will be known in advance exactly what specific output 40 is required from the device. This will be a value 42 that is required to enable or disable, or otherwise control, at least a part of the circuit of which the device forms a part. This might be viewed as the value that is required to lock or unlock that part of the circuit.

The detection arrangement will detect a feature of the unique output of the physical unclonable function, for example a location or magnitude of a peak or similar. This might be achieved in a setup or calibration phase, where inputs to the physical unclonable function are swept or otherwise varied until, say, a peak is detected in the output of the physical unclonable function. For example, the detection arrangement might initially be set to look for this feature as part of a device setup or calibration, but not thereafter, or not until there is some sort of reset of the device or system. The detection arrangement will then provide an output 44 dependent on the detection of the feature of this unique response.

The output 44 could be the actual voltage that is detected at a peak in a current-voltage characteristic, in one example. In another example, the output could be representative of (e.g. relating to or derived from) the detection of that peak. For instance, once the or a peak is detected, the peak value (or similar) could be normalised relative to the specific output level that is required 40, 42. A similar approach could be obtained when, say, determining the depth of a trough. The depth might not actually be the output, but instead a voltage representative of that depth. Detecting and outputting a peak or trough value might be simplest.

As described above, the input to the device that results in the detection the unique feature will be the specific input—e.g. the key.

It can be seen in FIG. 4 that the output 44 from the detection arrangement is not the specific output level that is required 40, 42. So, the offset arrangement is engineered or programmed in advance with reference to the specific output of the device that is required 40, 42, and from this can calculate or otherwise determine the offset 46 that is required to achieve the specific output is required 40, 42.

Finally, in later use, the same offset 46 will always be added to the detected output from the physical unclonable function. This is so that the exact specific output 40, 42 is only ever achieved when, in combination, the unique feature is detected and the related output 46 is made, and this is offset by the predetermined offset 46. Any other detection and related output will not result in the exact specific output 40, 42 being achieved.

Of course, the FIGS. 3 and 4 show different functional elements or processes as different blocks or other schematic forms, whereas in reality the functional elements or processes could be integrated onto one or more circuit boards or chips or similar.

As discussed briefly above, detection of the unique response is derivable from, in this case, electrical measurement of the output of the physical unclonable function. ‘Derivable’ might mean that the measurement might actually be the unique response. Alternatively, one or more features of the measurement may be used to provide the unique response. The unique response measured from the electrical output of physical unclonable function might be the presence or location of one or more peak, as described above. However, this is only an example, and in other examples the derivation of the unique response from the measured output might be a peak or a trough, or another particular feature or shape of the characteristic of a spectrum or other response to electrical input.

It has already been described above how the unique response derivable from the physical unclonable function is, in some embodiments, a voltage-current spectrum or features thereof, or derivable from such a spectrum. Of course, different spectra may be used, depending upon the way in which the structures are electrically challenged or the output therefrom measured, for example voltage, current, capacitance, resistance, memristance, or integrals or derivatives thereof.

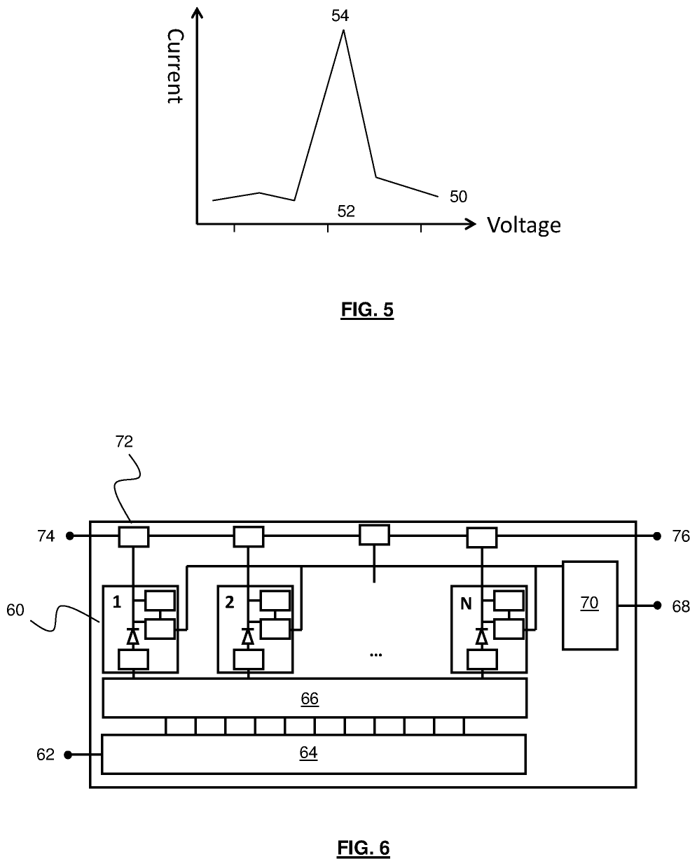

FIG. 5 depicts how a unique response can be obtained by the detection arrangement, and/or device as a whole. FIG. 5 shows that a voltage-current characteristic 50 of a structure could be measured or determined by sweeping an input voltage and measuring the output current, for example by diverting that current through a resistor, and passing the voltage dropped across it into an analogue-to-digital converter. A peak-finding algorithm could then locate the closest digitised value of voltage 52 corresponding to the peak 54, and produce this as an output of or for the detection arrangement.

Again, this sweep could be part of an initial setup of the device, or setup after a reset. The detection arrangement may play no part in the operation of the device after the offset has been established and set, or at least until a new offset is or maybe required, when such a sweep/other method for identifying a unique feature is needed. For example, this setup may be undertaken when the device is reset in some way, to change the specific input that is required to achieve the specific output—i.e. to change the key.

As already mentioned above, any electronic characteristic could be used in a similar way to the approach of FIG. 5. For example, voltage, current, capacitance, memristance, etc., could be employed. Equally, the integrals or derivatives of such properties could be taken. Any unique feature from the measurement could be used as an output or to provide the output, for example, peak height, peak width, peak position, distance between peaks etc. All of these will be unique to the physical unclonable function. Peaks or troughs or similar might be easier to process in terms of single value specific inputs, and allow the detection arrangement to be simpler, and even passive in nature. However, more complex approaches would be possible, for example an input range of values, from which a spectrum or part thereof could be obtained, and cross-checked or matched with an expected spectrum or part thereof. If, for example, the shape or other feature of that spectrum or part thereof matched, the output of the detection arrangement could be positive and/or normalised in some way unique to that spectrum or part thereof, for example a value indicative of curvature, gradient, width and so on. Of course, this would require a more complex detection arrangement, for example comprising a microprocessor or similar.

It is important to note that the sweeping of values input to the physical unclonable function, and looking for, say, a peak in an output value, may only need to be undertaken in a setup or calibration phase. After this, during normal use of the device, only the specific input to the device will be required, in order to obtain the specific output for enabling/disabling other elements to which the device is connected. As discussed above, any other input will not result in the specific output. In this normal use phase, the detection arrangement may simply output a single value that is the unique response particular to the specific input, whether that be the actual response or a response derived therefrom (e.g. the actual current/voltage output, or with some sort of normalisation or similar). The detection arrangement may provide no output at all after the initial setup. The output of the device as a whole might simply be the combination of the output of the physical unclonable function and the specific offset.

The previous Figures have at least hinted at the outputs all being positive, to provide a positive output. Of course, the implementation could be reversed, where one or more outputs are negative or in some way inverted, to change the operative state of the device. That is, by inverting the way in which the outputs are used, provided or processed, the device can be in a default enable or disable configuration (or a particular mode, e.g. state of control).

The device described above might find use in isolation. However, in combination a plurality of devices might find even greater use, and be even more secure.

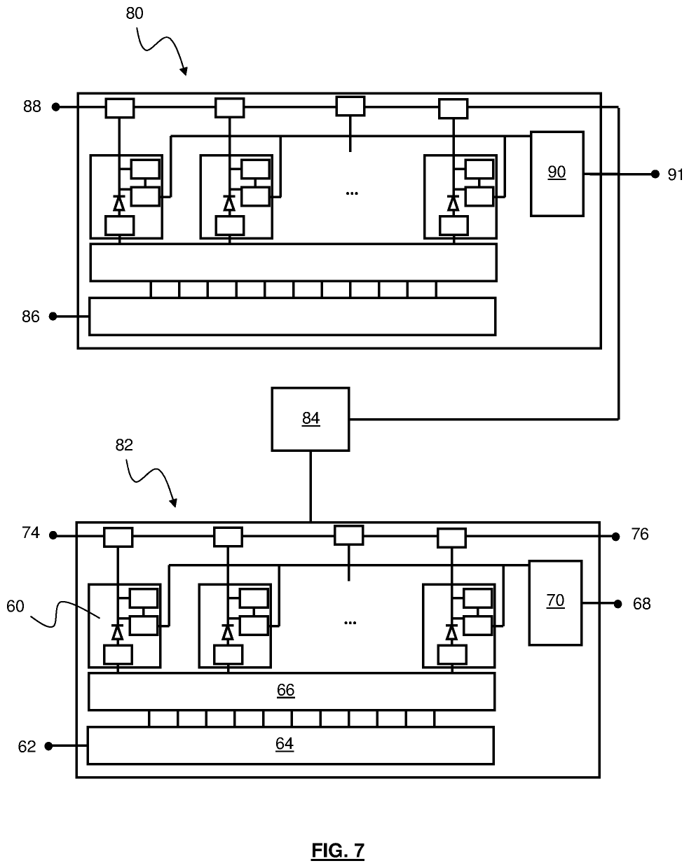

FIG. 6 shows a system in which a plurality of devices as described above are connected in parallel 60. A digital input to the cells may be provided via single connection 62. A serial to parallel shift register 64 and related buffer 66, with digital to analogue converters, provide input to each of the 1 to N devices 60. In an alternative approach, a series of analogue signals could be input to the devices 60 directly.

The detection arrangements of each device can be electrically connected, so that they can be read in whatever way suits—e.g. in sequence, in series, in parallel. As with the device described in isolation above, reading of the outputs 68 from the detection arrangements of the devices 60, which would give the specific input/key that triggered the unique feature detection, can be selectively disabled via a switch or fuse 70.

When the input to each device 60 is the specific input as described above, each device can provide a specific output that is sufficient to enable an associated switch or similar 72. The switch or similar 72 could be a transistor based arrangement, driven by current output from each respective device 60.

When all devices are provided with their own specific inputs required to enable their respective switches 72, a signal 74 may be transmitted through the closed switches to a signal output 76. If any one input to any one device is not the specific input for that device, its respective or associated switch will not allow passage of the signal 74.

Again, the situation could be reversed by inversion, so that the signal is transmitted through or via the switches 72, unless all inputs to all devices 60 are the specific inputs.

So, the more devices 60 there are connected in parallel, the more specific inputs that need to be known or determined in order to enable or disable connected circuitry. Each device serves as a tumbler in a lock. With devices connected in this manner, there is an exponential relationship between the time, effort or number of attempts at guessing each specific input, and the number of devices in the system. Given that it is already extremely difficult to achieve such circumvention with a single device, especially when the device has a physical unclonable function exhibiting quantum mechanical confinement, it would become virtually impossible to do this for a parallel-device system.

In these examples, the enabling or disabling via the specific outputs of the devices could be viewed as the enabling or disabling of the switches, or enabling or disabling of the passage of the signal, or enabling or disabling of some other circuitry via the blocking or passage of the signal.

In another example, not shown, switches or similar might not be required. Devices connected in parallel can be configured such than overall specific output is achieved only when each device provides its own specific output in response to its own specific input. The specific output could be the enabling/disabling signal in itself, for example controlling a single switch in a manner similar to that described in relation to FIG. 6.

The signal channel 74 of FIG. 6 could find a number of different uses. A single channel could be used for an analogue signal, a digital serial channel, or to control a power device such as a MOSFET. This could enable power to other connected devices. A combination of devices or system such as that shown in FIG. 6 could be used to control a parallel number of signal channels, for controlling a parallel bus. A system such as that of FIG. 6 could be used for each signal channel of such a parallel bus, or one or more of sub-set of those devices of such a system could each control such a signal channel.

With the parallel arrangements described so far, a matrix output of the devices is possible. For example, depending on what parts of the key are entered correctly, different elements of channels could be switched on. As an aid to understanding this principle, a system might be provided with eight devices in parallel. The first half of the key entered correctly with the remaining half as a cryptographic nonce would activate one channel. Similarly, the first half of the key entered as a cryptographic nonce, in combination with a correct second half of the key, could activate a second channel. All components of the key entered correctly could enable a third channel. This sort of arrangement could also be used for redundancy, so that given twenty device elements, only a subset (e.g. sixteen) need to be enabled to allow the control (on/off) of a channel.

In the examples so far, the channel is binary—on/off. However, the device elements could be used to enable or disable components that change the channel characteristics, such as switching in or out of capacitances, resistances, inductances, and so on, to change the speed at which data could be transmitted.

So far, devices and systems have been described in which specific inputs result in specific outputs, for example for enabling or disabling connected circuitry or components thereof. In another example, devices as described above, at least in general functional terms, could be used in master-slave arrangement. FIG. 7 shows such an example.

In FIG. 7, two systems similar to those shown in FIG. 6 are shown as being connected to one another, to form a master sub-system 80 and a slave sub-system 82. The slave sub-system 82 operates in exactly the same way as shown in FIG. 6. An input signal 74 can only be transmitted via the system 82 if all switches 72 are enabled. This, in turn, requires that the input 62 to all devices 60 is the specific input for each device 60. In this instance, this is the slave key.

The slave sub-system 82 may therefore be used as necessary, for example by an end user. However, a master or end user may want to reset the slave sub-system 82, for example if the system 82 (e.g. its key) is compromised, or if the end-user changes.

For certain physical unclonable functions, it is possible to alter the unique response that they generate, for example by overheating or overbiasing (which is thought to involved the same physics as overheating) the physical unclonable function. This is particularly true of physical unclonable functions that exhibit quantum mechanical confinement. So, by such heating or biasing, the physical unclonable functions can be made to provide new unique responses. As a result, following the logic and discussions above, a new key is required to ensure that the device having that physical unclonable function is able to provide the (desired) specific offset. That is, the new unique response or feature thereof needs to be detected, and a new specific offset needs to be determined. The sub-system 82 is reset. The master sub-system 80 can control the resetting.

The resetting of each physical unclonable function of one, more or all devices of the slave sub-system 82 can be driven by appropriate reset circuitry 84, driven by the master sub-system 80.

That same reset circuitry can selectively enable or disable the electronic switch or fuse 70 of the slave sub-system 82, which allows the unique responses, or at least the detection thereof, to be quickly determined and characterised via output 68. Appropriate offsets are calculated and implemented. Once reset, the reset circuitry 84 can enable or disable the electronic switch or fuse 70 of the slave sub-system 82 to prevent further reading of outputs from which the (new) slave key could otherwise be determined.

For the master sub-system 80, operation is similar but subtly different. An input 86 key for enabling or preventing passage of a signal 88 through the master-system is obtained as discussed above. In this case, though an electronic fuse or switch 90 that was used in the determination of the key (e.g. via an output 91) is permanently enabled or disabled in order to prevent further reading of information prejudicial to the identity of the key. The master key is now secure, at least in terms of being read from the sub-system 80 itself. By inputting 86 the master key to the sub-system 80, the signal 88 can be transmitted to the reset circuitry. The signal 88 can be configured to reset the physical unclonable functions of the devices 60 of the slave sub-system and/or to enable/disable the switch or fuse for reading outputs from the physical unclonable functions or detection arrangements associated therewith. Without the master key, the slave device cannot be reset or compromised.

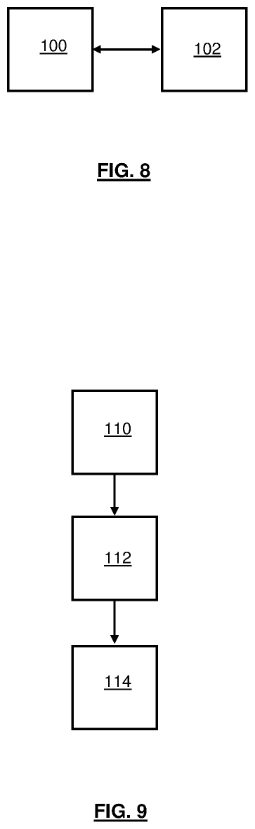

In the above examples, the device comprising the physical unclonable function has also been described as the very same device that undertakes the detection of output from those structures. However, FIG. 8 shows that this is not necessarily the case in all embodiments. In another example, as shown in FIG. 8, there may be a more system-like approach to the embodiment of the invention. The system might comprise a first device 100 arranged to provide a specific output in response to a specific input, the device comprising: a physical unclonable function, arranged to be challenged with an input and to provide an output in response to that input; the device being arranged to facilitate the detection of a unique output of the physical unclonable function, by a detection arrangement, in response to the specific input; an offset arrangement, configured to receive the unique output, and provide a specific offset to the unique output, in order to provide the specific output of the device in response to the specific input to the device. The system might comprise a second device 102, that second device being connected or connectable to the first device (e.g. via one or more contacts or connectors) in order to perform the detection of the unique output of the physical unclonable function, and to optionally provide the unique output to the offset arrangement. As discussed above, the device as a whole might be more secure if the detection is undertaken within the device itself. A compromise in the system of FIG. 8 could be where there is an electronic fuse or switch or similar that is located between the physical unclonable function and an external output, the fuse or switch or similar being enabled or disabled to prevent detection from an external device gaining access to the actual output of the physical unclonable function.

FIG. 9 is a flowchart depicting in more general form the methodology described above. The method comprises providing a specific output from a device in response to a specific input to the device. The method comprises: detecting a unique output of a physical unclonable function of the device in response to the specific input 110; providing a specific offset to the unique output 112, in order to provide the specific output 114 from the device in response to the specific input to the device.

The a physical unclonable function that exhibits quantum mechanical confinement has, in general, been described in the embodiments as a diode, and typically a resonant tunneling diode. However, other structures, and related forms or degrees of confinement are of course possible. For example, the structure that exhibits quantum mechanical confinement may define confinement in at least one dimension, in at least two dimensions, or in at least three dimensions. Greater confinement might result in more refined or sharper features in a resulting output, for example peaks or troughs in a spectrum. The structure that exhibits quantum mechanical confinement may comprise, be and/or provide one or more of: one or more tunneling barriers; a resonant tunneling diode; a Schottky barrier; a graphene nanoribbon; quantum mechanical confinement in a well; quantum mechanical confinement in a wire; quantum mechanical confinement in a layer; quantum mechanical confinement in a ring; quantum mechanical confinement in a dot.

So far, devices and systems have been described in which specific inputs result in specific outputs, for example for enabling or disabling connected circuitry or components thereof. In another example, the control might not be so binary, or bistable, or similar. That is, the specific output might be able to more generally control connected components or associated functionality. That is, and more generally, a certain component or certain functionality might only be possible (be in a certain state of control) when the output of the one or more described devices is the specific output or the specific outputs. This is still analogous to the lock and key examples above—functionality or general control of a particular type (e.g. in to or out of a certain state of control) is only allowed or ‘unlocked’ when the input is the specific input, such that the output is the specific output.

For example, the specific output could be input into a cryptographic algorithm or data for a micro-controller—the specific output need not be to a switch. A device as described above could be connected in such a way that when presented with the correct specific inputs, the specific outputs are set to provide inputs into more complicated devices or components, such as a microcontroller which runs a specific algorithm of some kind. The algorithm might (e.g. can) only be run when the outputs of the described devices are the specific outputs.

So, in a very simple case the described devices can be used with basic electronic elements to provide simple control functions. However, those same devices could be combined with a microcontroller, FPGA, or anything with more complexity than a simple switch, to drive (e.g. control) more complicated functions.

Again, and to reiterate, the physical unclonable function need not necessarily exhibit quantum mechanical confinement. However, such confinement has advantages.

In certain applications or implementations, the word “challenge” might have a very specific meaning, for example issuing a challenge to a device or structure to see if it responds in a way that is as expected (or otherwise), for example to determine if the device is authentic (or otherwise). However, in many embodiments above, the word “challenge” has been used more broadly, for example amounting to issuing a request, or read, or query to the device or a structure thereof. So, the terms might be used interchangeably, at least in some embodiments.

The unique response described above might alternatively or additionally be defined or described as a unique identifier, a key, or a fingerprint, and so on. This is to the extent that the terms might be used interchangeably.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A device arranged to provide a specific output in response to a specific input, the device comprising:
a physical unclonable function, arranged to be challenged with a specific input and to provide a unique output in response to that input;
the device being arranged to facilitate the detection of a feature of the unique output of the physical unclonable function, by a detection arrangement, in response to the specific input; and
an offset arrangement, configured to receive an output from the detection arrangement that is dependent on the detection of the feature of the unique output, and provide a specific offset to this output, in order to provide the specific output of the device in response to the specific input to the device.

2. The device of claim 1, wherein:
if an input to the device is not the specific input, an output of the device is not the specific output; and
if an output of the physical unclonable function does not comprise the feature, an output of the device is not the specific output.

3. The device of claim 1, wherein the offset arrangement is arranged to provide the same specific offset to the output of the detection arrangement, regardless of the output of the detection arrangement, or an output of the physical unclonable function.

4. The device of claim 1, wherein the offset arrangement is engineered or programmed in advance with reference to the specific output of the device, in order to provide the specific offset.

5. The device of claim 1, wherein the detection arrangement is part of the device.

6. The device of claim 5, wherein the detection arrangement is arranged to provide an output external to the device, such that it is possible to determine, external to the device, the output of the physical unclonable function.

7. The device of claim 6, wherein output of the detection arrangement external to the device is controlled via an electrically controllable switch or fuse.

8. The device of claim 1, wherein the physical unclonable function comprises a structure that exhibits quantum mechanical confinement, the structure being arranged to provide a unique response when challenged, the unique response being linked to the atomic makeup of the structure that defines the quantum mechanical confinement.

9. The device of claim 8, wherein the challenge comprises the device facilitating an electrical measurement of an electrical output of the structure, the electrical output optionally involving tunneling.

10. The device of claim 1, wherein the device comprises a time limitation element, arranged to impose a time limit as to when the physical unclonable function can be challenged, optionally after a previous challenge.

11. A system, comprising a plurality of devices as claimed in any preceding claim, connected in parallel.

12. (canceled)

13. A system, comprising:
the device of claim 1, serving as a first device; and
a second device, comprising the detection arrangement, the second device being connected or connectable to the first device in order to perform the detection of the feature of the unique output of the physical unclonable function, and to optionally provide an output that is dependent on the detection of the feature to the offset arrangement.

14. An electrical circuit comprising the device of claim 1, wherein at least a component of the electrical circuit is arranged to be controlled depending on whether the output of the device or system is the specific output.

15. A method of providing a specific output from a device in response to a specific input to the device, the method comprising:
detecting a feature of a unique output of a physical unclonable function of the device in response to the specific input; and
providing a specific offset to an output that is dependent on the detection of the feature of the unique output, in order to provide the specific output from the device in response to the specific input to the device.

16. The device of claim 1, wherein the device comprises one of a pair of devices including a respective physical unclonable function and offset arrangement, wherein the device comprises a master sub-system or a slave sub-system and the other of the pair of devices comprises the other of the master sub-system or the slave sub-system.
